(19) United States
(12) Patent Application Publication
(10) Pub. No.: US 2014/0160038 A1
(43) Pub. Date: Jun. 12, 2014

(54) TOUCH SENSING METHOD AND TOUCH SENSING APPARATUS

(71) Applicant: SAMSUNG ELECTRO-MECHANICS CO., LTD., Suwon (KR)

(72) Inventors: Hyun Suk LEE, Suwon (KR); Byeong Hak JO, Suwon (KR); Tah Joon PARK, Suwon (KR); Kang Joo KIM, Suwon (KR)

(73) Assignee: SAMSUNG ELECTRO-MECHANICS CO., LTD., Suwon (KR)

(21) Appl. No.: 13/772,503

(22) Filed: Feb. 21, 2013

(30) Foreign Application Priority Data
Dec. 12, 2012 (KR) 10-2012-0144133

(51) Int. Cl. G06F 3/041

(52) U.S. Cl. CPC G06F 3/041
USPC 345/173

(57) ABSTRACT

There are provided a touch sensing method and a touch sensing apparatus. The touch sensing method includes calibrating an offset value; obtaining sensed data from a panel unit, performing a difference operation on the sensed data and the offset value to calculate valid data, when the valid data is higher than a first threshold value, calculating a correlation value between the valid data and reference data, and comparing the correlation value with a second threshold value to determine whether to update the offset value and whether to filter the valid data.

### CROSS-REFERENCE TO RELATED APPLICATIONS

This application claims the priority of Korean Patent Application No. 10-2012-0144133 filed on Dec. 12, 2012, in the Korean Intellectual Property Office, the disclosure of which is incorporated herein by reference.

### BACKGROUND OF THE INVENTION

1. Field of the Invention

The present invention relates to a touch sensing method and a touch sensing apparatus in which an error in determining a touch caused by an error generated in calibrating a touchscreen is prevented through an operation of comparing valid data obtained by performing a difference operation on sensed data and an offset value with a threshold value and calculating a correlation value between reference data and the valid data, and a reference required for re-calibrating the touchscreen is provided.

2. Description of the Related Art

A touch sensing apparatus such as a touchscreen, a touch pad, or the like, is an input device attached to a display device to provide an intuitive input method to a user. Recently, a touch sensing apparatus has been widely applied to various electronic devices such as cellular phones, personal digital assistants (PDAs), navigation devices, and the like. In particular, recently, as demand for smartphones has increased, an employment rate of touchscreens as touch sensing apparatuses capable of providing various input methods in a limited area is on the rise.

Touchscreens employed in portable devices may be classified as resistive-type touchscreens and capacitive-type touchscreens according to a method of sensing a touch utilized thereby. Among these, capacitive touchscreens, having advantages in terms of relatively long lifespans and various easily implementable data input methods, has been increasingly applied. In particular, the capacitive touchscreen, facilitating implementation of a multi-touch interface relative to the resistive touchscreen, is extensively employed in devices such as smartphones, and the like.

The capacitive touchscreen includes a plurality of electrodes having a predetermined pattern, and a plurality of nodes in which capacitance is changed by a touch are defined by the plurality of electrodes. The plurality of nodes distributed on a two-dimensional (2D) plane generate a change in self-capacitance or in mutual-capacitance according to a touch applied thereto, and coordinates of a touch may be calculated by applying a weighted average calculation method, or the like, to the change in capacitance generated in the plurality of nodes. In order to accurately calculate coordinates of a touch, an offset value as a reference for determining a touch should be continuously updated according to an operating environment, and when an offset value is erroneously updated by a foreign object present on a panel unit, an unintentional touch operation of a user, or the like, a touch actually intended by the user may be erroneously recognized.

Cited reference 1 relates to a digital filtering method of a touch sensing system, disclosing a technique of filtering touch data and re-adjusting a noise level according to the filtering result. Cited reference 2 relates to a method for driving a touchscreen device, disclosing a configuration of calculating a noise reference based on an intensity of illumination, a temperature, and the like, and removing calculated noise from sensed data to determine a touch. However, cited references 1 and 2 do not disclose a technique of calculating a correlation value between valid data obtained by removing an offset value from sensed data and reference data and determining whether to update the offset value based on the calculation result.

### RELATED ART DOCUMENT

(Patent document 1) Korean Patent Laid Open Publication No. 10-2011-0128046
(Patent document 1) Korean Patent Registration Publication No. 10-1030001-0000

### SUMMARY OF THE INVENTION

An aspect of the present invention provides a touch sensing method and a touch sensing apparatus in which valid data obtained by removing an offset value from sensed data is compared with predetermined reference data to calculate a correlation value, and the calculated correlation value is compared with a threshold value to determine whether to update the offset value. Also, whether to update the offset value may even be determined by a sign (or a value) of valid data, irrespective of the correlation value, whereby the offset value applied in determining a touch may be set to be optimized for an operational environment.

According to an aspect of the present invention, there is provided a touch sensing method including: calibrating an offset value; obtaining sensed data from a panel unit; performing a difference operation on the sensed data and the offset value to calculate valid data; when the valid data is higher than a first threshold value, calculating a correlation value between the valid data and reference data; and comparing the correlation value with a second threshold value to determine whether to update the offset value and whether to filter the valid data.

The determining may include: when the correlation value is higher than the second threshold value, filtering the valid data and updating the offset value; and when the correlation value is lower than the second threshold value, determining a touch by using the valid data.

The method may further include: determining whether to update the offset value according to a value of the valid data.

The method may further include: when the value of the valid data is negative (−), updating the offset value; and when the value of the valid data is positive (+), comparing the valid data with the first threshold value.

The method may further include: when the valid data is lower than the first threshold value, updating the offset value.

The reference data may represent a range of values the sensed data may have and a range of values the offset value may have.

According to another aspect of the present invention, there is provided a touch sensing apparatus including: a reference data calculation unit calculating reference data applied to each of an offset value and sensed data obtained from a panel unit; a valid data calculation unit performing a difference operation on the sensed data and the offset value to calculate valid data; and a calculation unit calculating a correlation value between the valid data and the reference data when the valid data is higher than a first threshold value, wherein the calculation unit determines whether to update the offset value and whether to filter the valid data by comparing the correlation value with a second threshold value.

The apparatus may further include: a touch determining unit receiving the valid data from the calculation unit and determining at least one of coordinates of a touch, a number of touches, and a gesture according to the touch.

When the correlation value is higher than the second threshold value, the calculation unit may filter the valid data and transmit the same to the touch determining unit and update the offset value, and when the correlation value is lower than the second threshold value, the calculation unit may transmit the valid data to the touch determining unit as is.

The reference data calculation unit may calculate the reference data based on a range of values the offset value may have in a state that no touch is applied to the panel unit and a range of values the sensed data obtained from the panel unit may have.

When a value of the valid data is negative (−), the calculation unit may update the offset value.

When the value of the valid data is positive (+) and the valid data is lower than the first threshold value, the calculation unit may update the offset value, and when the value of the valid data is positive (+) and the valid data is higher than the first threshold value, the calculation unit may calculate a correlation value between the valid data and the reference data.

The apparatus may further include: a driving circuit unit applying a predetermined driving signal to at least a portion of a plurality of nodes included in the panel unit; and a sensing circuit unit obtaining the sensed data from the at least some nodes to which the driving signal has been applied.

According to another aspect of the present invention, there is provided a touch sensing apparatus including: a plurality of first electrodes extending in a first axial direction; a plurality of second electrodes extending in a second axial direction intersecting the first axial direction; and a controller integrated circuit (IC) detecting a change in capacitance generated between the plurality of first electrodes and the plurality of second electrodes, wherein the controller IC obtains valid data by subtracting an offset value from sensed data generated from the change in capacitance, and when the valid data is higher than a first threshold value, the controller IC calculates a correlation value between the valid data and reference data, and determines whether to filter the valid data by comparing the correlation value with a second threshold value.

When a value of the valid data is negative (−), the controller IC may update the offset value.

When the value of the valid data is positive (+) and the valid data is lower than the first threshold value, the controller IC may update the offset value, and when the value of the valid data is positive (+) and the valid data is higher than the first threshold value, the controller IC may calculate a correlation value between the valid data and the reference data.

When the correlation value is higher than the second threshold value, the controller IC may determine a touch by updating the offset value and filtering the valid data, and when the correlation value is lower than the second threshold value, the controller IC may determine a touch by using the valid data as is.

The controller IC may determine at least one of coordinates of a touch, a number of touches, and a gesture according to the touch based on the valid data.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating the exterior of an electronic device including a touch sensing apparatus according to an embodiment of the present invention;

FIG. 2 is a view illustrating a touchscreen panel unit that may be included in the touch sensing apparatus according to an embodiment of the present invention;

FIG. 3 is a circuit diagram of the touch sensing apparatus according to an embodiment of the present invention;

FIG. 4 is a flow chart illustrating a touch sensing method according to an embodiment of the present invention;

FIG. 5 is a block diagram of a touch sensing apparatus according to an embodiment of the present invention; and

FIG. 6 is a graph showing an operation of the touch sensing apparatus according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

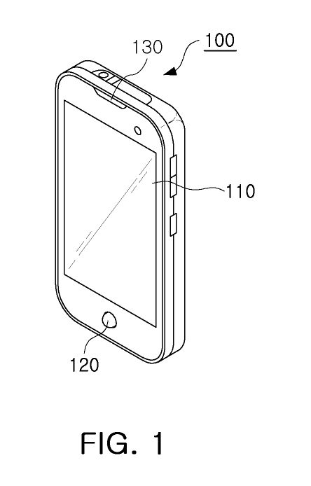

FIG. 1 is a perspective view illustrating the exterior of an electronic device including a touch sensing apparatus according to an embodiment of the present invention.

Referring to FIG. 1, an electronic device 100 according to the present embodiment may include a display unit 110 for outputting a screen, an input unit 120, an audio output unit 130 for outputting audio, and the like, and also, a touch sensing apparatus integrated with the display unit 110.

As illustrated in FIG. 1, in case of the mobile device, in general, a touch sensing apparatus is integrated with the display unit, and the touch sensing apparatus is required to have sufficient light transmittance to allow an image displayed on the display unit to be transmitted therethrough. Thus, the touch sensing apparatus may be implemented by forming a sensing electrode with a material such as indium tin oxide (ITO), indium zinc oxide (IZO), zinc oxide (ZnO), carbon nanotubes (CNT), or graphene having electrical conductivity on a base substrate made of a transparent film material such as polyethylene terephthalate (PET), polycarbonate (PC), polyethersulfone (PES), polyimide (PI), or the like. A wiring pattern connected to the sensing electrode made of a transparent conductive material is disposed in a bezel region of the display unit, and since the wiring pattern is visually shielded by the bezel region, the wiring pattern may also be made of a metal such as silver (Ag), copper (Cu), or the like.

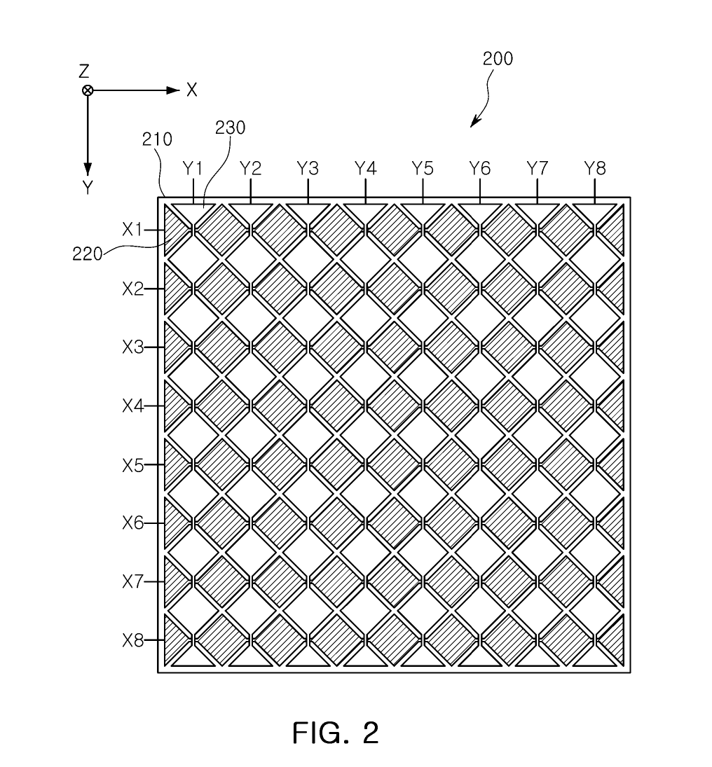

Of course, the touch sensing apparatus according to an embodiment of the present invention is assumed to operate according to a capacitive scheme, so it may include a plurality of electrodes having a predetermined pattern. Also, the touch sensing apparatus according to an embodiment of the present invention may include a capacitance sensing circuit detecting a change in capacitance generated by a plurality of electrodes, an analog-to-digital conversion circuit converting an output signal from the capacitance sensing circuit into a digital value, a calculation circuit determining a touch by using data which has been converted into the digital value, and the like. Hereinafter, the touch sensing apparatus and an operation method thereof according to an embodiment of the present invention will be described with reference to FIGS. 2 through 7.

FIG. 2 is a view illustrating a touchscreen panel unit that may be included in the touch sensing apparatus according to an embodiment of the present invention.

Referring to FIG. 2, a panel screen 200 according to the present embodiment includes a substrate 210 and a plurality of sensing electrodes 220 and 230 provided on the substrate 210. Although not shown, the plurality of sensing electrodes 220 and 230 may be electrically connected to a wiring pattern of a circuit board attached to one end of the substrate 210 through a wiring and a bonding pad, respectively. A controller integrated circuit (IC) may be mounted on the circuit board to detect sensing signals generated by the plurality of sensing electrodes 220 and 230 and determine a touch from the sensing signals.

In the case of the touchscreen device, the substrate 210 may be a transparent substrate on which the sensing electrodes 220 and 230 are formed, and may be made of a plastic material such as polyimide (PI), polymethylmethacrylate (PMMA), polyethyleneterephthalate (PET), or polycarbonate (PC), or tempered glass. Besides a region in which the sensing electrodes 220 and 230 are formed, a predetermined printed region for visually shielding a wiring generally made of an opaque metal may be formed on the substrate 210 with respect to a region in which the wiring connected to the sensing electrodes 220 and 230 is provided.

The plurality of sensing electrodes 220 and 230 may be formed on one surface of the substrate 210 or on both surfaces thereof. The touchscreen device may be made of ITO, IZO, ZnO, CNT, a graphene material, or the like, which has transparency and conductivity. In FIG. 2, the sensing electrodes 220 and 230 having a diamond-like pattern are illustrated, but the present invention is not limited thereto and the sensing electrodes 220 and 230 may also have various polygonal patterns such as a rectangular pattern, a triangular pattern, or the like.

The plurality of sensing electrodes 220 and 230 include first electrodes 220 extending in an X-axial direction and second electrodes 230 extending in a Y-axial direction. The first electrodes 220 and the second electrodes 230 may be formed on both surfaces of the substrate 210 or may be alternately formed on mutually different substrates 210. In the case in which both the first electrodes 220 and the second electrodes 230 are formed on one surface of the substrate 210, a predetermined insulating layer may be partially formed in intersections between the first electrodes 220 and the second electrodes 230.

The touch sensing apparatus, electrically connected to the plurality of sensing electrodes 220 and 230 to sense a touch, may detect a change in capacitance generated from the plurality of sensing electrodes 220 and 230 according to a touch applied thereto, and sense the touch based on the detected change in capacitance. The first electrodes 220 may be connected to channels defined as D1 to D8 in the control IC to receive a predetermined driving signal, and the second electrode 230 may be connected to channels defined as S1 to S8 so as to be used for the touch sensing apparatus to detect a sensing signal. Here, the controller IC may detect a change in mutual capacitance generated between the first electrodes 220 and the second electrodes 230, as a sensing signal, and operate to sequentially apply a driving signal to the respective first electrodes 220 and simultaneously detect a change in the capacitance in the second electrodes 230. Namely, when M number of first electrodes 220 and N number of second electrodes 230 are provided, the controller IC may detect M×N number of capacitance change data for determining a touch.

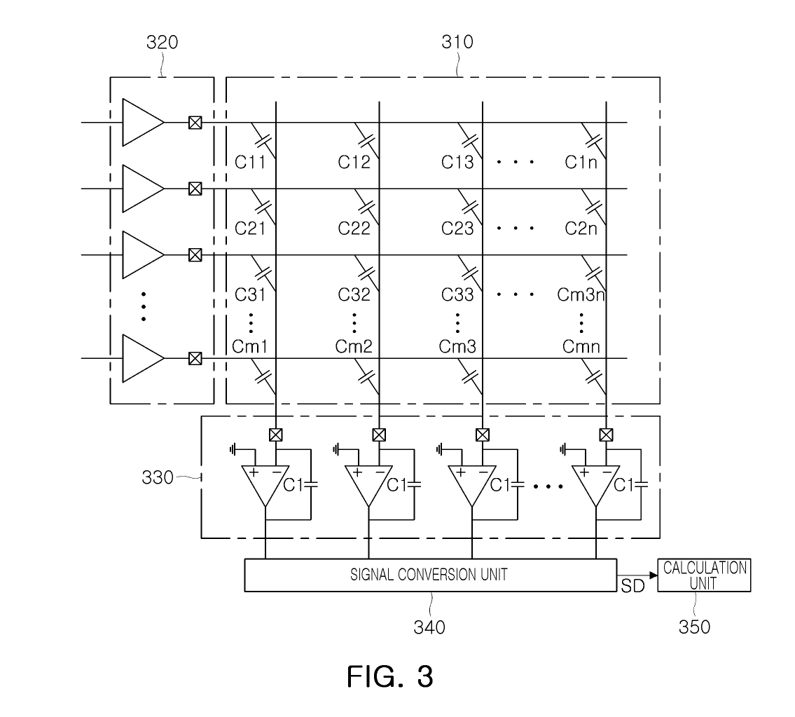

FIG. 3 is a circuit diagram of the touch sensing apparatus according to an embodiment of the present invention.

Referring to FIG. 3, the touch sensing apparatus according to an embodiment of the present invention includes a panel unit 310, a driving circuit unit 320, a sensing circuit unit 330, a signal conversion unit 340, and a calculation unit 350. The panel unit 310 includes m number of first electrodes extending in a first axial direction (or a horizontal direction in FIG. 3) and n number of second electrodes extending in a second axial direction (or a vertical direction in FIG. 3) crossing the first axis. Capacitance changes C11 to Cmn are generated in a plurality of nodes at which the first electrodes and the second electrodes intersect. The capacitance changes C11 to Cmn generated in the plurality of nodes may be changes in mutual capacitance generated by a driving signal applied to the first electrodes by the driving circuit unit 320. Meanwhile, the driving circuit unit 320, the sensing circuit unit 330, the signal conversion unit 340, and the calculation unit 350 may be implemented as a single integrated circuit (IC).

The driving circuit unit 320 applies a predetermined driving signal to the first electrodes. The driving signal may have a square wave form, a sine wave form, a triangle wave form, or the like, having a predetermined period and amplitude, and may be sequentially applied to the plurality of respective first electrodes. In FIG. 3, circuits for generating and applying driving signals are individually connected to the plurality of respective first electrodes, but the present invention is not limited thereto and it may be configured such that a single driving signal generation circuit is provided and a driving signal may be applied to a plurality of respective first electrodes by using a switching circuit. Also, the driving signal may be simultaneously applied to all the first electrodes or may be selectively applied to only a portion of the first electrodes to simply detect presence or absence of a touch.

The sensing circuit unit 330 may include an integrating circuit for sensing the capacitance changes C11 to Cmn generated in the plurality of nodes. The integrating circuit may be connected to the plurality of second electrodes. The integrating circuit may include at least one operational amplifier and a capacitor C1 having a certain capacity. An inverting input terminal of the operational amplifier is connected to the second electrode to convert capacitance changes C11 to Cmn into an analog signal such as a voltage signal, or the like, and output the same. When driving signals are sequentially applied to the plurality of respective first electrodes, capacitance changes may be simultaneously detected from the plurality of second electrodes, so n number of integrating circuits corresponding to the second electrodes may be provided.

The signal conversion unit 340 generates a digital signal SD from the analog signal generated by the integrating circuit. For example, the signal conversion unit 340 may include a time-to-digital converter (TDC) circuit measuring a time during which an analog signal in a voltage form output by the sensing circuit unit 330 reaches a predetermined reference voltage level and converting the same into a digital signal SD, or may include an analog-to-digital converter (ADC) circuit measuring an amount by which a level of an analog signal output by the sensing circuit unit 330 changes for a predetermined time and converting the same into a digital signal SD. The calculation unit 350 may determine a touch applied to the panel unit 310 by using the digital signal SD. In an embodiment of the present invention, the calculation unit 350 may determine a number of touches applied to the panel unit 310, coordinates of a touch, a gesture, or the like.

The digital signal SD used as a reference for the calculation unit 350 to determine a touch may be data obtained by digitizing the capacitance changes C11 to Cmn, and in particular, it may be data indicating a difference of capacitance between a case in which a touch has not been generated and a case in which a touch has been generated. In general, in a touch sensing apparatus based on a capacitance scheme, a region in which a conductive object is in contact has reduced capacitance relative to a region in which a touch has not been applied.

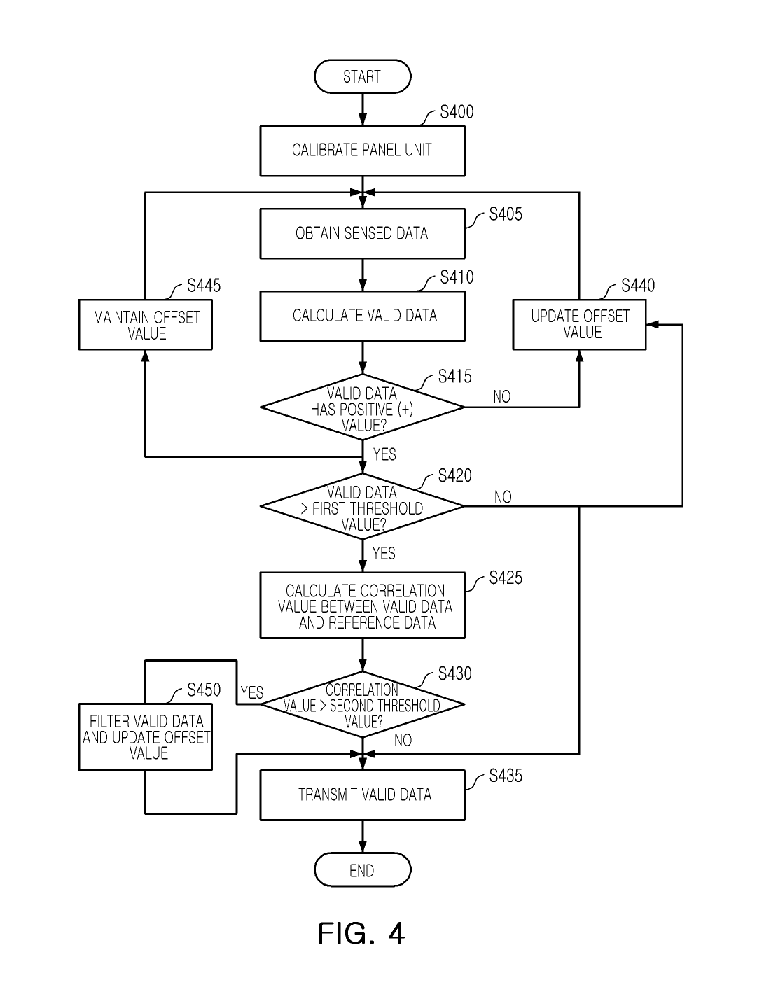

FIG. 4 is a flow chart illustrating a touch sensing method according to an embodiment of the present invention.

Referring to FIG. 4, a touch sensing method according to the present embodiment starts from calibrating the panel unit 310 (S400). As discussed above, sensed data generated when a touch is applied to the panel unit 310 is provided as a difference value between an offset value determined on the assumption that no touch is applied and sensed data obtained when a touch is applied. Thus, periodically, or in a case in which an operational environment of the panel unit 310 is determined to have been changed, the panel unit 310 may be calibrated to update or maintain the offset value.

After the calibration, the touch sensing apparatus obtains sensed data from the panel unit 310 (S405). In order to obtain the sensed data, the driving circuit unit 320 sequentially applies a driving signal to the plurality of first electrodes, respectively, and the sensing circuit unit 330 may detect a change in capacitance from the plurality of second electrodes intersecting the first electrodes to which the driving signal has been applied. The sensing circuit unit 330 may detect a change in capacitance in the form of an analog signal by using the integrating circuit, and the analog signal output from the sensing circuit unit 330 may be converted into a digital signal S_{D} by the signal conversion unit 340. The calculation unit 350 may determine the touch by using the digital signal S_{D} as sensed data.

When the sensed data is obtained, the calculation unit 350 may subtract the offset value from the sensed data to calculate valid data (S410). The offset value subtracted from the sensed data is a value determined in calibrating the panel unit 310, and the calculation unit 350 first determines a value of the valid data calculated in operation S410 (S415).

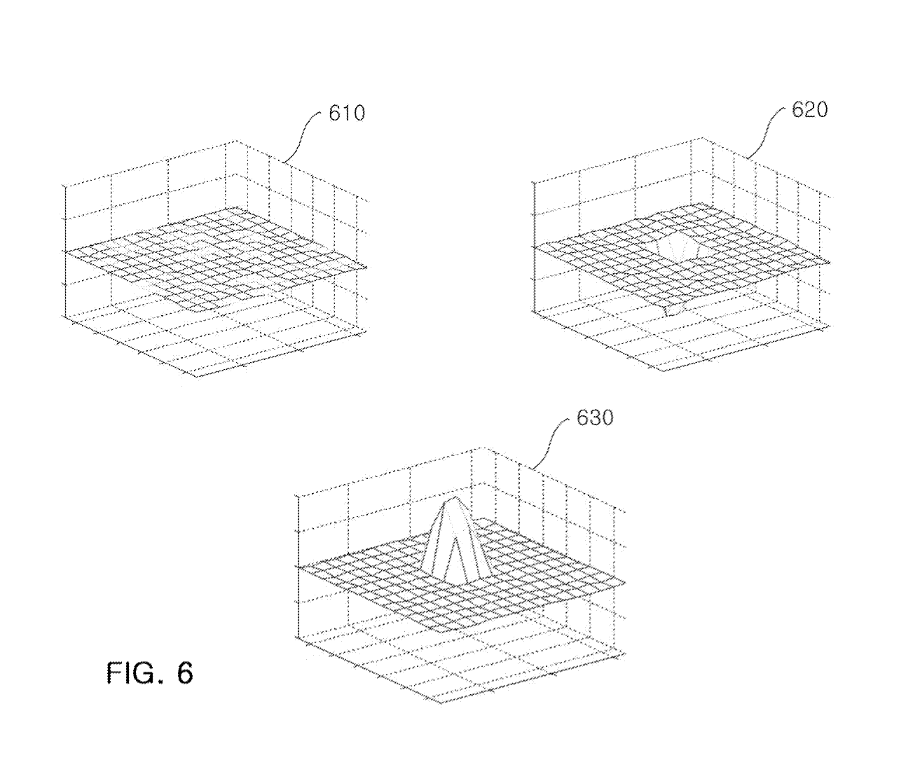

When the value of the valid data is determined to be a negative value in operation S415, the calculation unit 350 updates the offset value. Hereinafter, the case in which the value of the valid data is negative will be described with reference to the graph of FIG. 6.

Referring to FIG. 6, a total of three graphs are illustrated. A first graph 610 may correspond to a case in which a calibration operation is performed on the panel unit 310 while a user's touch is being applied, namely, for example, while a user's finger is in contact with the panel unit 310. Thus, data shown in the first graph 610 is set as an offset value.

Meanwhile, a second graph 620 is sensed data that may be obtained when the user's finger in contact with the panel unit 310 is separated from the panel unit 31 after the offset value is set in the form of the first graph 610. As discussed above, when a conductive object such as the user's finger, or the like, is brought into contact with the panel unit 310, capacitance is discharged to the conductive material, and as a result, sensed data is obtained such that a data value is reduced in a peripheral region of the region with which the conductive object is in contact.

However, in FIG. 6, since the case in which the calibration operation is performed to set the offset value as shown in the first graph 610 while the object such as the user's finger, or the like, is in contact with the panel unit 310 is assumed, when the user's finger is separated from the panel unit 310, data values are increased in the region with which the user's finger was in contact and a peripheral region thereof as shown in the second graph 620. As a result, value data that may be obtained through a difference operation between the offset value and the sensed data may appear to have a reverse direction of a normal touch operation, namely, to have a negative (−) sign (or a negative (−) value), as shown in the third graph 630.

In the touch sensing apparatus and the touch sensing method proposed in the present embodiment, when the valid data has a negative (−) sign, the panel unit 310 is calibrated again or an offset value is updated to prevent an error in determining a touch. As illustrated in the flow chart of FIG. 4, when the valid data is determined to have a negative (−) sign in operation S415, the offset value is updated without performing any particular determination on the touch (S440).

Meanwhile, when the valid data is determined to have a positive (+) sign (or a positive (+) value) in operation S415, the calculation unit 350 maintains the offset value (S445) and compares the valid data value with a first threshold value (S420). Here, the first threshold value may be a reference value for determining whether the valid data is data which has been generated by an actual touch.

When the valid data is determined to be lower than the first threshold value according to the determination result in operation S420, the calculation unit 350 updates the offset value (S440). When the valid data is lower than the first threshold value, it corresponds to a case in which sensed data has been generated due to noise, a foreign object applied from the outside, or the like, rather than an actual touch, so the calculation unit 350 updates the offset value.

Meanwhile, when the valid data is determined to be higher than the first threshold value according to the determination result in operation S420, the calculation unit 350 calculates a correlation value between the valid data and the reference data (S425). The reference data may be data including a range of values the sensed data obtained from the panel unit 310 may have or a range of values the offset value may have.

When the correlation value between the valid data and the reference data is calculated, the calculation unit 350 compares the correlation value with a second threshold value (S430). When the correlation value is higher than the second threshold value, the calculation unit 350 may determine that the valid data calculated in operation S410 has resulted from a residual image of a foreign object, or the like, filter the valid data, and update the offset value (S450). Meanwhile, when the correlation value is lower than the second threshold value, the calculation unit 350, the calculation unit 350 may transmit the valid data calculated in operation S410 as is to a microcontroller unit (MCU) (S435). The MCU may determine a number of touches, coordinates of a touch, a gesture, or the like.

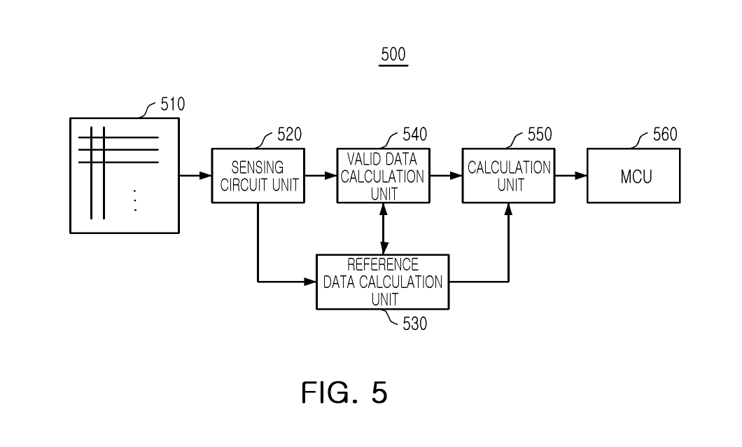

FIG. 5 is a block diagram of a touch sensing apparatus according to an embodiment of the present invention.

Referring to FIG. 5, a touch sensing apparatus 500 according to the present embodiment may include a panel unit 510, a sensing circuit unit 520, a reference data calculation unit 530, a valid data calculation unit 540, a calculation unit 550, and the like. An MCU 560 may be disposed in a rear stage of the calculation unit 550 and determine a number of touches, coordinates of a touch, a gesture, or the like.

A change in capacitance generated from a plurality of nodes included in the panel unit 510 may be detected as sensed data by the sensing circuit unit 520 and delivered to the reference data calculation unit 530 and the valid data calculation unit 540. Based on the sensed data, the reference data calculation unit 530 may generate first reference data with respect to the sensed data. Also, the reference data calculation unit 530 may generate second reference data with respect to an offset value set for a current operational environment of the panel unit 510 together.

The valid data calculation unit 540 may calculate valid data through difference operation between the offset value and the sensed data. The calculation unit 550 may determines whether a value of the calculated data is positive (+) or negative (−) to determine whether the currently obtained sensed data has been generated by a normal touch. As discussed above, when the valid data has a negative (−) value, the calculation unit 550 may update the offset value.

Meanwhile, when the valid data has a positive (+) value, the calculation unit 550 may receive the reference data from the reference data calculation unit 530 and calculate a correlation value between the valid data and the reference data. Here, the calculation unit 550 may calculate a first correlation value between the first reference data with respect to the sensed data and the valid data and a second correlation value between the second reference data with respect to the offset value and the valid data, respectively.

The calculation unit 550 may compare the first and second correlation values with a threshold value, and when the correlation values are higher than the threshold value, the calculation unit 550 may determine that the valid data has resulted from a residual image of a foreign object, or the like, filter the valid data, and update the offset value. Meanwhile, when the correlation value is lower than the threshold value, the calculation unit 550 may transmit the valid data to the MCU 560 without performing a filtering operation. The MCU 560 finally determines the touch by using the valid data received from the calculation unit 550.

As set forth above, according to embodiments of the invention, when the value data without an offset value is higher than a first threshold value, a correlation value between the valid data and reference data is calculated and compared with a second threshold value. When the correlation value is higher than the second threshold value, it is determined that an error was generated at an initial stage of calibrating the touchscreen, and the valid data is filtered and an offset value is updated. Namely, since an error of an offset value set in calibrating the touchscreen at an initial stage is detected based on the valid data, the offset value can be accurately set as a value optimized for an operational environment, based on which a touch error can be reduced.

While the present invention has been shown and described in connection with the embodiments, it will be apparent to those skilled in the art that modifications and variations can be made without departing from the spirit and scope of the invention as defined by the appended claims.

What is claimed is:

1. A touch sensing method comprising:
calibrating an offset value; obtaining sensed data from a panel unit;
performing a difference operation on the sensed data and the offset value to calculate valid data;
when the valid data is higher than a first threshold value, calculating a correlation value between the valid data and reference data; and
comparing the correlation value with a second threshold value to determine whether to update the offset value and whether to filter the valid data.

2. The method of claim 1, wherein the determining comprises:
when the correlation value is higher than the second threshold value, filtering the valid data and updating the offset value; and
when the correlation value is lower than the second threshold value, determining a touch by using the valid data.

3. The method of claim 1, further comprising:
determining whether to update the offset value according to a value of the valid data.

4. The method of claim 3, further comprising:
when the value of the valid data is negative (−), updating the offset value; and
when the value of the valid data is positive (+), comparing the valid data with the first threshold value.

5. The method of claim 4, further comprising: when the valid data is lower than the first threshold value, updating the offset value.

6. The method of claim 5, wherein the reference data represents a range of values the sensed data can have and a range of values the offset value can have.

7. A touch sensing apparatus comprising:
a reference data calculation unit calculating reference data applied to each of an offset value and sensed data obtained from a panel unit;
a valid data calculation unit performing a difference operation on the sensed data and the offset value to calculate valid data; and
a calculation unit calculating a correlation value between the valid data and the reference data when the valid data is higher than a first threshold value,
wherein the calculation unit determines whether to update the offset value and whether to filter the valid data by comparing the correlation value with a second threshold value.

8. The touch sensing apparatus of claim 7, further comprising: a touch determining unit receiving the valid data from the calculation unit and determining at least one of coordinates of a touch, a number of touches, and a gesture according to the touch.

9. The touch sensing apparatus of claim 8, wherein when the correlation value is higher than the second threshold value, the calculation unit filters the valid data and transmits the same to the touch determining unit and updates the offset value, and
when the correlation value is lower than the second threshold value, the calculation unit transmits the valid data to the touch determining unit as is.

10. The touch sensing apparatus of claim 7, wherein the reference data calculation unit calculates the reference data based on a range of values the offset value can have in a state that no touch is applied to the panel unit and a range of values the sensed data obtained from the panel unit can have.

11. The touch sensing apparatus of claim 7, wherein when a value of the valid data is negative (−), the calculation unit updates the offset value.

12. The touch sensing apparatus of claim 7, wherein when the value of the valid data is positive (+) and the valid data is lower than the first threshold value, the calculation unit updates the offset value, and
when the value of the valid data is positive (+) and the valid data is higher than the first threshold value, the calculation unit calculates a correlation value between the valid data and the reference data.

13. The touch sensing apparatus of claim 7, further comprising:
a driving circuit unit applying a predetermined driving signal to at least a portion of a plurality of nodes included in the panel unit; and
a sensing circuit unit obtaining the sensed data from the at least some nodes to which the driving signal has been applied.

14. A touch sensing apparatus comprising:
a plurality of first electrodes extending in a first axial direction;
a plurality of second electrodes extending in a second axial direction intersecting the first axial direction; and
a controller integrated circuit (IC) detecting a change in capacitance generated between the plurality of first electrodes and the plurality of second electrodes,
wherein the controller IC obtains valid data by subtracting an offset value from sensed data generated from the change in capacitance, and when the valid data is higher than a first threshold value, the controller IC calculates a correlation value between the valid data and reference data, and
determines whether to filter the valid data by comparing the correlation value with a second threshold value.

15. The touch sensing apparatus of claim 14, wherein when a value of the valid data is negative (−), the controller IC updates the offset value.

16. The touch sensing apparatus of claim 14, wherein when the value of the valid data is positive (+) and the valid data is lower than the first threshold value, the controller IC updates the offset value, and
when the value of the valid data is positive (+) and the valid data is higher than the first threshold value, the controller IC calculates a correlation value between the valid data and the reference data.

17. The touch sensing apparatus of claim 14, wherein when the correlation value is higher than the second threshold value, the controller IC determines a touch by updating the offset value and filtering the valid data, and
when the correlation value is lower than the second threshold value, the controller IC determines a touch by using the valid data as is.

18. The touch sensing apparatus of claim 14, wherein the controller IC determines at least one of coordinates of a touch, a number of touches, and a gesture according to the touch based on the valid data.
